(19) United States
(12) Patent Application Publication
(10) Pub. No.: US 2026/0074298 A1
(43) Pub. Date: Mar. 12, 2026

(54) ELECTRICITY STORAGE DEVICE

(71) Applicant: Prime Planet Energy & Solutions, Inc., Tokyo (JP)

(72) Inventors: Shota YAMAMOTO, Kobe-shi (JP); Ryoichi WAKIMOTO, Kobe-shi (JP); Hiroaki IMANISHI, Kobe-shi (JP)

(21) Appl. No.: 19/299,341

(22) Filed: Aug. 14, 2025

(30) Foreign Application Priority Data
Sep. 11, 2024 (JP) 2024-157164

(51) Int. Cl. H01M 10/42; H01M 50/103; H01M 50/15; H01M 50/548; H01M 50/586; H01M 50/627

(52) U.S. Cl. CPC H01M 10/4214; H01M 50/103; H01M 50/15; H01M 50/548; H01M 50/586; H01M 50/627

(57) ABSTRACT

The present disclosure provides a technique for making an electrolytic solution efficiently osmose into an electrode assembly. A herein disclosed electricity storage device includes a case having a liquid injection part, an electrode assembly, a resin film surrounding the electrode assembly, and an electrolytic solution. The case includes a bottom wall, an upper wall, and a first side wall. The liquid injection part is provided at a position closer to the upper wall of the first side wall. The resin film includes a first end part extending from one side in a predetermined direction to cover a part of a bottom part of the electrode assembly, and includes a second end part extending along the predetermined direction from a direction different from the first end part. A part of the second end part is stacked at the bottom wall side of the case with respect to the first end part.

### CROSS REFERENCE TO RELATED APPLICATIONS

The present application claims the priority based on Japanese Patent Application No. 2024-157164 filed on Sep. 11, 2024. The entire contents of the prior application are incorporated in the present specification by reference.

### BACKGROUND

The present disclosure relates to an electricity storage device.

Japanese Patent Application Publication No. 2007-42628 discloses a secondary battery that includes an electrode assembly group formed in a jelly roll format. This secondary battery has a configuration, in which a positive electrode terminal is provided at one end of a case and a negative electrode terminal is provided at an opposite side.

Japanese Patent Application Publication No. 2019-29218 discloses an insulation holder configured to accommodate the electrode assembly. This insulation holder has a configuration of covering a bottom surface side of the electrode assembly.

### SUMMARY

A manufacturing method of the electricity storage device could include an impregnating step for impregnating the electrode assembly with an electrolytic solution at the case inside. In the impregnating step, it is required to efficiently osmose the electrolytic solution into the electrode assembly. However, in a situation where a periphery of the electrode assembly is covered with the insulation holder, there is a possibility that it becomes hard to osmose the electrolytic solution into the electrode assembly.

One aspect of a herein disclosed technique is an electricity storage device, including a case that includes a liquid injection part, including an electrode assembly that is accommodated by the case, including a resin film that is arranged between the case and the electrode assembly to surround the electrode assembly, and including an electrolytic solution that is accommodated by the case. The case includes a bottom wall, an upper wall that is opposed to the bottom wall, and a first side wall that extends from a border of the bottom wall to a border of the upper wall. The liquid injection part is provided at a position closer to the upper wall than the bottom wall of the first side wall. The electrode assembly is arranged to have a bottom part being opposed to the bottom wall. The resin film includes a first end part that extends from one side in a predetermined direction to cover a part of the bottom part of the electrode assembly, and a second end part that extends along the previously determined direction from a direction opposite to the first end part and extends to cover a part of the bottom part of the electrode assembly. A part of the second end part is stacked to overlap at the bottom wall side of the case with respect to the first end part.

According to the above described electricity storage device, it is possible to efficiently osmose the electrolytic solution into the electrode assembly.

### BRIEF DESCRIPTION OF THE DRAWINGS

FIG. 1 is a perspective view of an electricity storage device in accordance with one embodiment.

FIG. 2 is a perspective view in which the electricity storage device in accordance with one embodiment is shown from a view point different from FIG. 1.

FIG. 3 is a cross section view that schematically shows an inside structure of the electricity storage device of FIG. 1.

FIG. 4 is a cross section view that schematically shows a structure of an electrode assembly in accordance with one embodiment.

FIG. 5 is a cross section view that schematically shows an inside structure of the electricity storage device of FIG. 1 from a view point different from FIG. 3.

FIG. 6 is a cross section view that schematically shows a configuration of an area between the electrode assembly and a bottom wall.

### DETAILED DESCRIPTION

Below, some embodiments of a technique disclosed herein would be described in detail, by reference to accompanying drawings. The matters other than matters particularly mentioned in this specification, and required for practicing the present disclosure (for example, a general configuration of the electricity storage device, manufacture process, or the like, which does not characterize the present disclosure) can be grasped as design matters of those skilled in the art based on the related art in the present field. The present disclosure can be implemented on a basis of contents disclosed in the present specification and a common general technical knowledge. Incidentally, in the following accompanying drawings, the same numerals and signs are given to the members/parts providing the same effect. Additionally, a dimensional relation (such as length, width, and thickness) in each drawing does not always reflect an actual dimensional relation.

In the present specification, a term “electricity storage device” represents a concept semantically covering a device that can generate a charge and discharge response by having a charge carrier moving between a pair of electrodes (a positive electrode and a negative electrode). In other words, the electricity storage device semantically covers a battery, such as secondary battery (for example, a lithium ion secondary battery, a nickel hydrogen battery, and a nickel cadmium battery), and a capacitor (a physical battery), such as lithium ion capacitor and electric double layer capacitor.

In the present specification, a wording “square tube shape” represents a tube shape whose cross section orthogonal to an axial direction has an opening part being polygonal (for example, a quadrangle). Incidentally, a corner part, at which a side and a side of the polygon come into contact with each other, might be formed in an R shape.

In the present specification, a wording “approximately rectangular shape” means a term semantically covering not only a complete rectangular shape (an oblong shape), but also, for example, a shape whose corner part, at which a long side and a short side of the rectangular shape are connected, is formed in the R shape, a shape whose corner part includes a notch, or the like.

### Electricity Storage Device

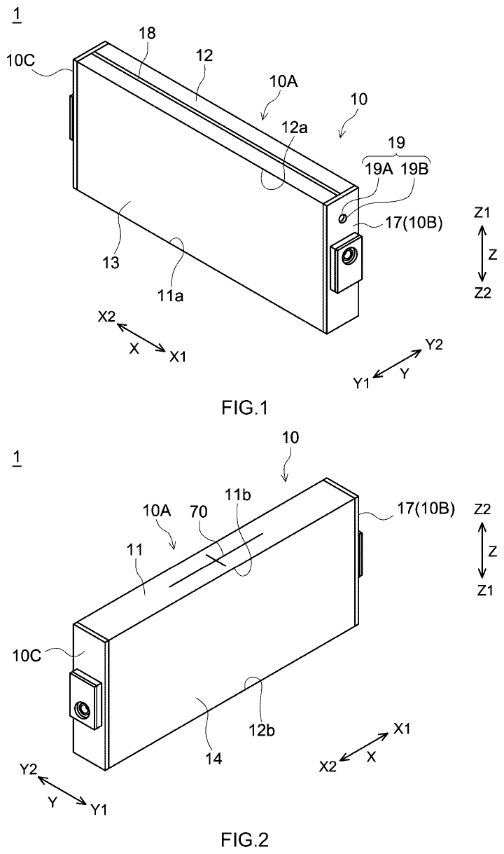

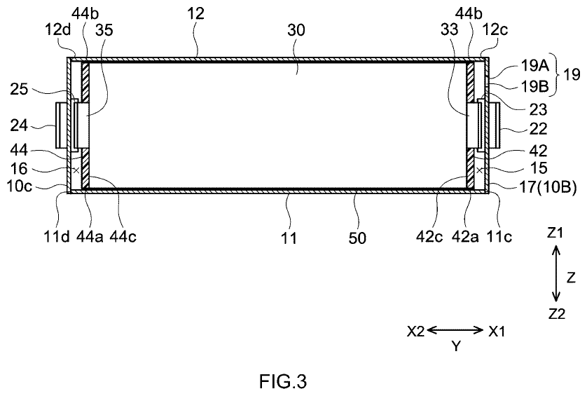

Below, as one embodiment, an electricity storage device 1 will be described. FIG. 1 is a perspective view that schematically shows the electricity storage device in accordance with one embodiment. FIG. 2 is a perspective view that shows the electricity storage device in accordance with one embodiment from a view point different from FIG. 1. FIG. 3 is a cross section view that schematically shows an inside structure of the electricity storage device of FIG. 1. In the present specification, reference signs X, Y, and Z of drawings are respectively referred to as a first direction, a second direction, and a third direction. In addition, X1, X2, Y1, Y2, Z1, and Z2 of drawings are reference signs for showing correspondences of directions of respective drawings. However, these directions are for convenience sake of explanation, and are not intended to particularly restrict a disposed aspect of the electricity storage device.

As shown in FIG. 1 to FIG. 3, the electricity storage device 1 includes a case 10, a positive electrode terminal 22, a negative electrode terminal 24, an electrode assembly 30, a first spacer 42, a second spacer 44, a resin film 50, and an electrolytic solution (whose illustration is omitted). The case 10 includes a liquid injection part 19 configured for injecting the electrolytic solution to an inside. The electricity storage device 1 herein is a lithium ion secondary battery. Below, each configuration will be described.

### (1) Case

As shown in FIG. 1 to 2, the case 10 includes a bottom wall 11, an upper wall 12, and a first side wall 17. In the present embodiment, the case 10 includes a case main body 10A, a first lid 10B, and a second lid 10C. The case main body 10A includes the bottom wall 11, the upper wall 12, a first wide side wall 13, and a second wide side wall 14. The first lid 10B is arranged as the first side wall 17. The case 10 is disposed to make the bottom wall 11 be positioned at a lower side in a vertically direction than the upper wall 12 when the electrode assembly 30 is impregnated with the electrolytic solution.

The case main body 10A is a member formed in a square tube shape that includes a first opening 15 at one end in the first direction X (a X1 side in FIG. 1) and includes a second opening 16 at the other end (a X2 side in FIG. 1). The bottom wall 11 and the upper wall 12 are opposed to each other in the third direction Z. Each of the bottom wall 11 and the upper wall 12 is formed in a plate shape. Each of the bottom wall 11 and the upper wall 12 has an approximately rectangular shape in a plane view. Each of the bottom wall 11 and the upper wall 12 includes a long side extending along the first direction X.

The first wide side wall 13 and the second wide side wall 14 are opposed to each other in the second direction Y. The first wide side wall 13 and the second wide side wall 14 have area sizes larger than the bottom wall 11 and the upper wall 12. The first wide side wall 13 extends from a border (a long side) 11a of the bottom wall 11 to a border (a long side) 12a of the upper wall 12. The second wide side wall 14 extends from a border (a long side) 11b of the bottom wall 11 to a border (a long side) 12b of the upper wall 12. Each of the first wide side wall 13 and the second wide side wall 14 is formed in a plate shape. Each of the first wide side wall 13 and the second wide side wall 14 has an approximately rectangular shape. Each of the first wide side wall 13 and the second wide side wall 14 includes a long side extending along the first direction X.

The case main body 10A can be manufactured, for example, by folding and bending one metal plate so as to mold it in a cylindrical shape, and then by joining (for example, welding and joining) a seam. Thus, on the case main body 10A shown by FIG. 1, a welded and joined part 18 extending along the first direction X is formed on the upper wall 12. Incidentally, a material of the case main body 10A could be a metal material, such as aluminum, aluminum alloy, iron, and iron alloy. From a perspective of tractableness, it is preferable that the case main body 10A is configured with aluminum or aluminum alloy.

On the bottom wall 11, a safe valve 70 is provided. The safe valve 70 is a thin-walled part that is designed to be broken when an inside of the case 10 reaches a predetermined pressure, and designed to release the internal pressure. In some embodiments, the safe valve 70 could be provided, not on the bottom wall 11 of the case 10, but on the upper wall 12 or the side wall. Two or more safe valves 70 might be provided.

As shown in FIG. 3, the first side wall 17 extends from a border (a short side) 11c of the bottom wall 11 to a border (a short side) 12c of the upper wall 12. In the present embodiment, as the first side wall 17, the first lid 10B is arranged. The first lid 10B is installed on the first opening 15 and covers the first opening 15. The first lid 10B is a plate-shaped member formed in an approximately rectangular shape. As shown in FIG. 3, the first lid 10B extends from the border (the short side) 11c of the bottom wall 11 to the border (the short side) 12c of the upper wall 12. The first lid 10B is stacked on end surfaces of the bottom wall 11, the upper wall 12, the first wide side wall 13, and the second wide side wall 14 of the case main body 10A, and then joined to them. A joined method is not particularly restricted, but the case main body 10A and the first lid 10B are joined, for example, by welding and joining. As a material of the first lid 10B, a metal material which is the same kind as the case main body 10A (aluminum, aluminum alloy, iron, iron alloy, or like) is suitable.

The first lid 10B includes a liquid injection part 19. The liquid injection part 19 includes a liquid injection hole 19A and a sealing plug 19B. As shown in FIG. 3, the liquid injection hole 19A penetrates the first lid 10B so as to communicate the inside and the outside of the case 10. In manufacturing the electricity storage device 1, the electrolytic solution is injected to the inside of the case 10 through the liquid injection hole 19A. After the liquid injection of the electrolytic solution, the liquid injection hole 19A is sealed by the sealing plug 19B. Accordingly, the case 10 is hermetically sealed and thus a leakage of the electrolytic solution is inhibited.

In the present embodiment, the liquid injection part 19 is provided at a position closer to the upper wall 12 than the bottom wall 11 of the first lid 10B. Accordingly, it is possible to inhibit the leakage of the electrolytic solution from the liquid injection hole 19A when the electrode assembly 30 is impregnated with the electrolytic solution injected to the inside of the case 10.

The second lid 10C is installed on the second opening 16 and covers the second opening 16. The second lid 10C is a plate-shaped member formed in an approximately rectangular shape. The second lid 10C is opposed to the first lid 10B. As shown in FIG. 3, the second lid 10C extends from a border (a short side) 11d of the bottom wall 11 to a border (a short side) 12d of the upper wall 12. The second lid 10C is opposed to the first lid 10B. The first lid 10B is stacked on end surfaces of the bottom wall 11, the upper wall 12, the first wide side wall 13, and the second wide side wall 14 of the case main body 10A, and then joined to them. A joined method is not particularly restricted, but the case main body 10A and the second lid 10C are joined, for example, by welding and joining. As a material of the second lid 10C, the metal material which is the same kind as the case main body 10A (aluminum, aluminum alloy, iron, iron alloy, or like) is suitable. Incidentally, the second lid 10C is an example of the second side wall opposed to the first side wall 17 included by the case 10.

### (2) Electrode Terminal

The positive electrode terminal 22 is attached to the first lid 10B. A part of the positive electrode terminal 22 is exposed to the outside of the case 10. It is preferable that the positive electrode terminal 22 is made of metal, and it is further preferable that the positive electrode terminal is made of, for example, aluminum or aluminum alloy. The positive electrode terminal 22 is, as shown in FIG. 3, electrically connected to the positive electrode sheet 32 (for more detail, a positive electrode tab 33 described later) of the electrode assembly 30 via a positive electrode current collector part 23 at the inside of the case 10. The positive electrode current collector part 23 might be a part of the positive electrode terminal 22 or might be the other member made of metal.

The negative electrode terminal 24 is attached to the second lid 10C. The negative electrode terminal 24 is provided at a side opposite to the positive electrode terminal 22 in the first direction X. A part of the negative electrode terminal 24 is exposed to the outside of the case 10. It is preferable that the negative electrode terminal 24 is made of metal, and it is further preferable that the negative electrode terminal is made of, for example, copper or copper alloy. The negative electrode terminal 24 is, as shown in FIG. 3, electrically connected to the negative electrode sheet 34 (for more detail, a negative electrode tab 35 described later) of the electrode assembly 30 via a negative electrode current collector part 25 at the inside of the case 10. The negative electrode current collector part 25 might be a part of the negative electrode terminal 24 or might be the other member made of metal.

### (3) Electrode Assembly

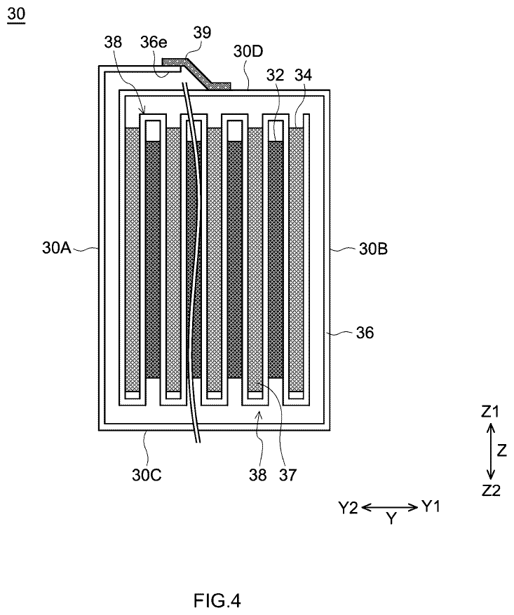

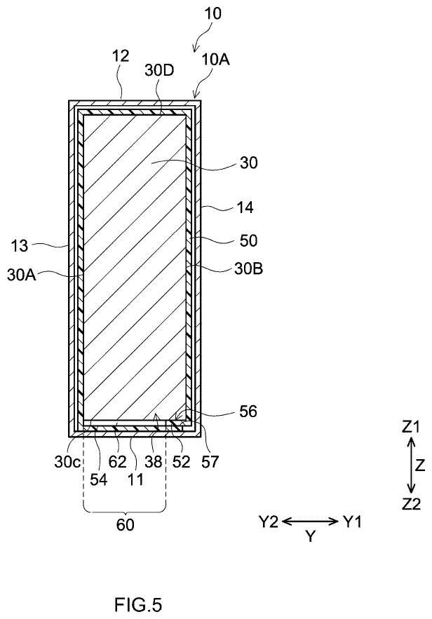

The electrode assembly 30 is a power generating element on the electricity storage device 1. As shown in FIG. 3, the electrode assembly 30 is accommodated at the inside of the case 10. FIG. 4 is a cross section view that schematically shows a structure of the electrode assembly 30. FIG. 5 is a cross section view that schematically shows an inside structure of the electricity storage device of FIG. 1 from a view point different from FIG. 3. In FIG. 5, a detailed structure of the electrode assembly 30 is omitted. The electrode assembly 30 includes a first wide surface 30A, a second wide surface 30B, a bottom part 30C, and an upper part 30D. The first wide surface 30A is opposed to the first wide side wall 13 of the case 10 at the inside of the case 10. The second wide surface 30B is a surface opposed to the first wide surface 30A. The second wide surface 30B is opposed to the second wide side wall 14 of the case 10 at the inside of the case 10. The bottom part 30C is opposed to the bottom wall 11 of the case 10 at the inside of the case 10. The upper part 30D is opposed to the bottom part 30C. The upper part 30D is opposed to the upper wall 12 of the case 10 at the inside of the case 10.

As shown in FIG. 4, the electrode assembly 30 includes a positive electrode sheet 32, a negative electrode sheet 34, and a separator sheet 36. The positive electrode sheet 32 and the negative electrode sheet 34 are alternately laminated via the separator sheet 36. In the present embodiment, regarding the electrode assembly 30, the first wide surface 30A and the second wide surface 30B are laminated along opposed directions. In the present specification, the lamination direction is referred to as a thickness direction of the electrode assembly 30, too.

In the present embodiment, the separator sheet 36 is formed in a zigzag shape which is alternately folded by a predetermined interval (referred to as a bellows-like shape, too). Regarding the electrode sheet (the positive electrode sheet 32 and the negative electrode sheet 34), both surfaces (laminated surfaces) in the thickness direction of the electrode sheet is sandwiched by a folded separator sheet 36. The separator sheet 36 is wound on an outermost periphery portion of the zigzag shape structure, so as to form an outer periphery surface of the electrode assembly 30. At a terminal end part 36e of the separator sheet 36, a winding stop tape 39 is pasted to prevent looseness of winding.

The electrode assembly 30 includes an osmose area 38 which becomes an entrance for osmosing the electrolytic solution from the outside to the inside of the electrode assembly 30. The osmose area 38 includes an inflow channel 37 at an electrode gap (inside of the electrode assembly 30) between the positive electrode sheet 32 and the negative electrode sheet 34 where the electrolytic solution can osmose. In the present embodiment, a surface orthogonal to a lamination direction of the electrode sheets (the positive electrode sheet 32, and the negative electrode sheet 34) contains the osmose area 38. On the osmose area 38, an end surface of the electrode sheet (a surface orthogonal to a thickness direction of the electrode sheet) could be exposed. In the present embodiment, the bottom part 30C of the electrode assembly 30, the upper part 30D, a surface opposed to the first lid 10B, and a surface opposed to the second lid 10C include the osmose area 38. The bottom part 30C including the osmose area 38 is opposed to the bottom wall 11 of the case 10 at the inside of the case 10. Thus, the electrolytic solution can osmose from a side of the bottom wall 11 of the case 10 to the inside of the electrode assembly 30.

The inflow channel 37 could be an entrance portion of a communication hole that extends to the inside of the electrode assembly 30. The separator sheet 36 could be a porous sheet into which the electrolytic solution can osmose. Thus, in the present embodiment, the separator sheet 36 arranged between the positive electrode sheet 32 and the negative electrode sheet 34 adjacent to this includes the inflow channel 37.

Incidentally, in some embodiments, the inflow channel 37 might be a slit or a gap provided on a surface of the separator sheet 36 or the surface of the electrode sheet.

Incidentally, regarding the electrode assembly 30 shown by FIG. 4, the separator sheet 36 is wound on the outermost periphery portion of the zigzag shape structure. In other words, the bottom part 30C including the osmose area 38 is covered by an outer periphery surface of the separator sheet 36. However, the separator sheet 36 includes the communication hole which can allow the osmose of the electrolytic solution. Thus, the electrolytic solution at an outer side of the electrode assembly 30 can pass through the separator sheet 36 to the osmose area 38.

The positive electrode sheet 32 includes a positive electrode current collector foil, and a positive electrode active material layer that is formed on at least one surface of the positive electrode current collector foil. A material of the positive electrode current collector foil is a metal material having an electrically conductive property. As the positive electrode current collector foil, it is possible to use, for example, aluminum, aluminum alloy, or like. As shown in FIG. 3, at an end part of the positive electrode current collector foil (the X1 side in drawings), the positive electrode tab 33 extending from the electrode assembly 30 is provided. The positive electrode tab 33 is opposed to the first lid 10B. The positive electrode tab 33 includes a current collector foil exposed part on which the positive electrode current collector foil is exposed. The current collector foil exposed part is joined to the positive electrode current collector part 23. The positive electrode active material layer includes a positive electrode active material. The positive electrode active material is a material capable of reversibly storing and releasing the charge carrier. The positive electrode active material might be similar to conventional one, and is not particularly restricted. The positive electrode active material could be a lithium-transition metal complex oxide, such as lithium-nickel-cobalt-manganese composite oxide, or like. The positive electrode active material layer might include an arbitrary component other than the positive electrode active material, such as binder and electrically conducting material.

The negative electrode sheet 34 includes a negative electrode current collector foil and a negative electrode active material layer that is formed on at least one surface of the negative electrode current collector foil. A material of the negative electrode current collector foil is the metal material that has the electrically conductive property. As the negative electrode current collector foil, it is possible to use, for example, copper, copper alloy, or like. As shown in FIG. 3, at an end part of the negative electrode current collector foil (the X2 side in drawings), the negative electrode tab 35 extending from the electrode assembly 30 is provided. The negative electrode tab 35 is opposed to the second lid 10C. The negative electrode tab 35 includes a current collector foil exposed part on which the negative electrode current collector foil is exposed. The current collector foil exposed part is joined to the negative electrode current collector part 25. The negative electrode active material layer includes a negative electrode active material. The negative electrode active material is the material capable of reversibly storing and releasing the charge carrier. The negative electrode active material might be similar to conventional one, and is not particularly restricted. The negative electrode active material might be, for example, a carbon material, such as graphite, a silicon-base material, or the like. The negative electrode active material layer might contain an arbitrary component other than the negative electrode active material, such as binder, thickening agent, and dispersing agent.

The separator sheet 36 might be similar to conventional one, and is not particularly restricted. The separator sheet 36 might have a single layer structure, or might have a structure configured with two or more layers whose properties or characteristics (thicknesses, porosities, or the like) are different from each other, for example, 3 layers structure. The separator sheet 36 is, for example, made of resin, and it is preferable to make it consist of a polyolefin resin. As the polyolefin resin, it is preferable to use polyethylene, polypropylene, or a mixture of them.

### (4) Electrolytic Solution

The electrolyte might be similar to conventional one, and is not particularly restricted. The electrolytic solution is, for example, a nonaqueous electrolytic solution containing a nonaqueous solvent (an organic solvent) and a supporting salt (an electrolyte salt, such as lithium salt and sodium salt). As one example of the nonaqueous solvent, it is possible to use carbonates, such as ethylene carbonate, dimethyl carbonate, and ethyl methyl carbonate. As one example of the supporting salt, it is possible to use a fluorine-containing lithium salt, such as lithium hexafluorophosphate (LiPF₆).

### (5) Spacer

As shown in FIG. 3, the first spacer 42 is arranged between the first lid 10B and the electrode assembly 30. The first spacer 42 includes a bottom side surface 42a opposed to the bottom wall 11 and includes an upper side surface 42b opposed to the upper wall 12. The first spacer 42 includes a base part 42c extending from the bottom side surface 42a to the upper side surface 42b. The base part 42c is arranged to cover a surface of the electrode assembly 30, the surface being opposed to the first lid 10B. By the first spacer 42, it is possible to inhibit the electrode assembly 30 and the first lid 10B directly come into contact with each other, so as to inhibit the electrode assembly 30 from being broken.

It is preferable that the first spacer 42 consists of an insulating resin. As the insulating resin, it is possible to use, for example, a polyamide resin, a polyolefin resin (for example, polypropylene, or polyethylene), or the like. By making the first spacer 42 have the insulating property, it is possible to inhibit a continuity between the electrode assembly 30 and the first lid 10B.

As shown in FIG. 3, the second spacer 44 is arranged between the second lid 10C and the electrode assembly 30. The second spacer 44 includes a bottom side surface 44a opposed to the bottom wall 11 and includes an upper side surface 44b opposed to the upper wall 12. The second spacer 44 includes a base part 44c extending from the bottom side surface 44a to the upper side surface 44b. The base part 44c is arranged to cover a surface of the electrode assembly 30, the surface being opposed to the second lid 10C. By the second spacer 44, it is possible to inhibit the electrode assembly 30 and the second lid 10C from directly come into contact with each other, so as to inhibit the electrode assembly 30 from being broken.

It is preferable that the second spacer 44 consists of the insulating resin. An example of the insulating resin might be similar to one of the first spacer 42 described above.

### (6) Resin Film

As shown in FIG. 3 and FIG. 5, the resin film 50 is an insulating member arranged between the case 10 and the electrode assembly 30. The resin film 50 is arranged to surround an outer periphery of the electrode assembly 30. Regarding the present embodiment, the resin film 50 is formed in a tube shape. At the inside of the cylindrical resin film 50, the electrode assembly 30 is accommodated. The resin film 50 covers the first wide surface 30A, the second wide surface 30B, the bottom part 30C, and the upper part 30D. Accordingly, the continuity between the electrode assembly 30 and the case main body 10A is inhibited.

In the present embodiment, at least a part of the first spacer 42 and at least a part of the second spacer 44 are arranged at the inside of the resin film 50. Thus, it is possible to further suitably inhibit the continuity between the electrode assembly 30 and the case 10.

In the present embodiment, the resin film 50 is manufactured by arranging the electrode assembly 30, on which the first spacer 42 and the second spacer 44 are attached at both sides, on one film and then by folding and bending the above described film to be formed in a cylindrical manner and to surround peripheries of the electrode assembly 30, the first spacer 42, and the second spacer 44. In some embodiments, the resin film 50 might be configured with two or more films.

A material of the resin film 50 might be, for example, a polyamide resin, a polyolefin resin (for example, polypropylene, or polyethylene), or the like. In addition, the resin film 50 might be a porous material into which the electrolytic solution can osmose.

In another aspect, the present inventor considers to implement making the electrolytic solution, stored at the bottom side of the case, easily osmose into the electrode assembly. The impregnating step, at which the electrolytic solution is made to osmose into the inside of the electrode assembly, is a step especially taking much time among the manufacturing steps of the electricity storage device. Thus, as the electrolytic solution is made to further easily osmose into the electrode assembly, the manufacturing time for the electricity storage device can be shorten further.

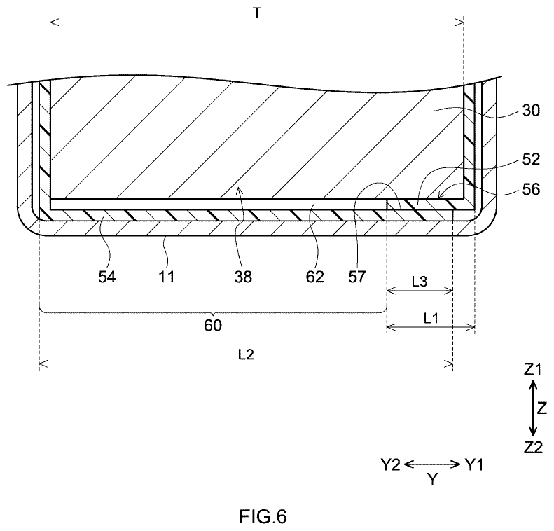

FIG. 6 is a cross section view that schematically shows a configuration of an area between the electrode assembly 30 and the bottom wall 11. As shown in FIG. 5 and FIG. 6, the resin film 50 includes a first end part 52 and a second end part 54. The second end part 54 and the first end part 52 are positioned between the bottom part 30C of the electrode assembly 30 and the bottom wall 11.

The first end part 52 covers a part of the bottom part 30C of the electrode assembly 30. The first end part 52 is a part of the resin film 50 arranged between the bottom part 30C of the electrode assembly 30 and the bottom wall 11 of the case 10, and the part is a portion extending from one side to the other side in a predetermined direction. In the present embodiment, the first end part 52 is configured to extend in a thickness direction of the electrode assembly 30 (the second direction Y) from the second wide surface 30B side (the Y1 side) of the electrode assembly 30 to the first wide surface 30A side (the Y2 side).

The second end part 54 covers a part of the bottom part 30C of the electrode assembly 30. The second end part 54 is a part of the resin film 50 arranged between the bottom part 30C of the electrode assembly 30 and the bottom wall 11 of the case 10, and the part is a portion extending from the other side to one side in the predetermined direction. In the present embodiment, the second end part 54 is configured to extend in the thickness direction of the electrode assembly 30 (the second direction Y) from the first wide surface 30A side (the Y2 side) of the electrode assembly 30 to the second wide surface 30B side (the Y1 side).

The resin film 50 includes an overlap part 56 in which at least a part of the first end part 52 and a part of the second end part 54 are stacked to overlap with each other. On the overlap part 56, the first end part 52 is positioned at the bottom part 30C side of the electrode assembly 30 and the second end part 54 is positioned at the bottom wall 11 side of the case 10. On the overlap part 56, an opposed area 57 of the first end part 52 and second end part 54 is not completely covered. The opposed area 57 includes a gap in which the electrolytic solution can pass through.

As shown in FIG. 5 and FIG. 6, the second end part 54 includes an electrode assembly opposed part 60 which is opposed to the bottom part 30C of the electrode assembly 30 not through the first end part 52. The electrode assembly opposed part 60 is provided continuously to the overlap part 56. Between the electrode assembly opposed part 60 and the bottom part 30C of the electrode assembly 30, a first space 62 is formed. In the present embodiment, the first space 62 is a space caused by a matter that a thickness of the second end part 54 is smaller than a thickness of the overlap part 56. The first space 62 is configured to face the bottom part 30C of the electrode assembly 30 and to communicate with the osmose area 38.

Regarding the present technique, as described above, the resin film 50 includes the overlap part 56 in which the first end part 52 and the second end part 54 are overlapped at the bottom part 30C of the electrode assembly 30. In addition, there is the electrode assembly opposed part 60 in which the second end part 54 is opposed to the electrode assembly 30 not through the first end part 52. Between the electrode assembly opposed part 60 and the bottom part 30C of the electrode assembly 30, there is the first space 62. Regarding the second end part 54 and the overlap part 56, a portion between the first end part 52 and the second end part 54 is not covered, thus the electrolytic solution can pass through, and therefore the electrolytic solution enters into the first space 62. The electrolytic solution having entered into the first space 62 osmoses from the osmose area 38 to the electrode assembly 30. Thus, it is possible to make the electrolytic solution efficiently osmose into the electrode assembly 30.

As shown in FIG. 6, a mean length L2 of the second end part 54 might be longer than a mean length L1 of the first end part 52. The mean length L1 of the first end part 52 and the mean length L2 of the second end part 54 are respectively arithmetical means of lengths in their extending directions. In the present embodiment, as shown by FIG. 6, the mean length L1 and the mean length L2 are lengths in the thickness direction of the electrode assembly 30 (the second direction Y). Thus, in comparison with a situation where the mean length L1 of the second end part 54 is shorter than the mean length L2 of the first end part 52, the first space 62 is formed to be wider, and thus it is possible to make the electrolytic solution further efficiently osmose to the inside of the electrode assembly 30.

A rate of an area size of the electrode assembly opposed part 60, when an area size of the bottom part 30C of the electrode assembly 30 is treated as 100%, is not particularly restricted, but it is good to be, for example, equal to or more than 50%, equal to or more than 60%, equal to or more than 70%, or equal to or more than 80%. As the area size of the electrode assembly opposed part 60 is larger, the electrolytic solution existing at the first space 62 can come into contact with a wider range of the osmose area 38, and thus it is possible to enhance an impregnation efficiency. On the other hand, from a perspective of securing an area size of the overlap part 56 and inhibiting a positional displacement of the first end part 52 and the second end part 54, the above described area size rate of the electrode assembly opposed part 60 is preferably, for example, equal to or less than 95%, or equal to or less than 90%, although not particularly restricted.

A rate of the area size of the overlap part 56, when the area size of the bottom part 30C of the electrode assembly 30 is treated as 100%, is not particularly restricted, but it is good to be, for example, equal to or less than 50%, equal to or less than 40%, equal to or less than 30%, or equal to or less than 20%. As the rate of the area size of the overlap part 56 is smaller, it becomes easier to make the electrolytic solution pass through the gap of the opposed area 57 of the overlap part 56, and thus it becomes easier to make the electrolytic solution enter into the first space 62. On the other hand, from the perspective of securing the area size of the overlap part 56 and inhibiting the positional displacement of the first end part 52 and the second end part 54, the above described area size rate of the overlap part 56 is preferably, for example, equal to or more than 5%, or equal to or more than 10%, although not particularly restricted.

As shown in FIG. 6, the mean length L1 of the second end part 54, when a thickness T of the electrode assembly 30 (see FIG. 6) is treated as 100, is, for example, equal to or more than 70, equal to or more than 80, or equal to or more than 90, although not particularly restricted. As the second end part 54 is longer, it is further possible to narrow the space between the first end part 52 and the bottom wall 11. The space described above should be not too wide, because there is a fear that the electrolytic solution is retained. On the other hand, if the space described above becomes too narrow, there is a possibility that the electrolytic solution does not easily enter from the space described above into the first space 62 through the gap of the overlap part 56. Thus, the mean length L2 of the second end part 54 is preferably, for example, equal to or less than 98, or equal to or less than 95, although not particularly restricted.

As shown in FIG. 6, the mean length L1 of the first end part 52, when the thickness T of the electrode assembly 30 (see FIG. 6) is treated as 100, is, for example, equal to or less than 50, equal to or less than 40, equal to or less than 30, or equal to or less than 20, although not particularly restricted. As the first end part 52 is shorter, it is further possible to widen the first space 62. By making the first space 62 be wider, it is possible to hold more electrolytic solution in the first space 62 and thus it is possible to enhance the impregnation efficiency. On the other hand, if the first end part 52 is too short, the first end part 52 becomes easily turned up. Thus, the mean length L1 of the first end part 52 is preferably, for example, equal to or more than 5, or equal to or more than 10, although not particularly restricted.

As shown in FIG. 6, a mean length L3 of the overlap part 56, when the thickness T of the electrode assembly 30 (see FIG. 6) is treated as 100, is preferably, for example, equal to or less than 50, equal to or less than 40, equal to or less than 30, or equal to or less than 20, although not particularly restricted. As the mean length L3 of the overlap part 56 is shorter, it becomes easier to make the electrolytic solution pass through the gap of the overlap part 56, and thus it becomes easier to make the electrolytic solution enter into the first space 62. On the other hand, from the perspective of securing the area size of the overlap part 56 and inhibiting the positional displacement of the first end part 52 and the second end part 54, the mean length L3 of the overlap part 56 is preferably, for example, equal to or more than 5, or equal to or more than 10, although not particularly restricted.

A thickness of the resin film 50 is not particularly restricted, but is, for example, equal to or more than 50 μm, equal to or more than 100 μm, or equal to or more than 150 μm. As the thickness of the resin film 50 is larger, it is possible to secure the wider first space 62 so as to enhance the impregnation efficiency. On the other hand, as the thickness of the resin film 50 becomes larger, a capacity of the electricity storage device 1 becomes smaller. Thus, the thickness of the resin film 50 could be, for example, equal to or less than 300 μm, equal to or less than 250 μm, or equal to or less than 200 μm.

Although the second end part 54 and the first end part 52 might be partially welded on the overlap part 56, it is further preferable that the overlap part 56 is not welded on an area where the electrode assembly 30 and the bottom wall 11 are opposed to each other. Because, the electrolytic solution is further efficiently supplied to the first space 62. In the present embodiment, the resin film 50 is welded to the bottom side surface 42a of the first spacer 42 and to the bottom side surface 44a of the second spacer 44. Accordingly, it is possible to fix the resin film 50 at the periphery of the electrode assembly 30, without welding the overlap part 56 onto the area where the electrode assembly 30 and the bottom wall 11 are opposed to each other.

The electricity storage device 1 can be used for various purposes. As a suitable purpose, it is possible to select an automotive application, in particular, a driving power supply that is mounted on a vehicle, such as battery electric vehicle (BEV), hybrid electric vehicle (HEV), and plug-in hybrid electric vehicle (PHEV). In addition, the electricity storage device 1 can be used as a storage battery, such as small electric power storage apparatus. The electricity storage device 1 can be used typically even in a form of a battery module consisting of plural ones connected in series and/or in parallel.

Above, some embodiments have been explained, but the above described embodiments are merely examples. The present technique can be implemented in the other various embodiments. The technique recited in the appended claims includes variously deformed or changed versions of the embodiments that have been illustrated above. For example, one part of the above described embodiment can be replaced with another deformed aspect, and furthermore another alternative aspect can be added to the above described embodiment. In addition, unless a technical feature is explained to be essential, this technical feature can be appropriately deleted.

In the above described embodiment, as the first side wall 17 including the liquid injection part 19, the first lid 10B was used. However, in some embodiments, the first side wall including the liquid injection part might be a part of the case main body.

In the above described embodiment, the case 10 included 2 lids 10B, 10C, but the present technique is not particularly restricted by the number of the lids. In some embodiments, the number of the lids might be 1. In addition, the case might not include the lid.

In the above described embodiment, each wall configuring the case was a plate-shaped part formed in the approximately rectangular shape. However, in some embodiments, each wall configuring the case might be formed in a square or a polygon.

In the above described embodiment, the electrode assembly 30 was the laminate electrode assembly including the zigzag shape structure in which the separator sheet 36 formed in the strip-like shape was used, but it is not restricted by this if the electrode assembly including the osmose area 38 is used. For example, the electrode assembly might be a laminate electrode assembly that is manufactured by preparing plural separator sheets, and then by sandwiching and laminating 1 or 2 separator sheets between the positive electrode sheet and the negative electrode sheet. In addition, it might be a wound electrode assembly in which the positive electrode sheet formed in a strip-like shape and the negative electrode sheet formed in a strip-like shape are stacked via the separator sheet formed in a strip-like shape and then the resultant is wound therein. In a situation where it is the wound electrode assembly, the osmose area could be formed at both sides in the winding axis direction.

In the above described embodiment, one electrode assembly 30 was accommodated in the case 10, but in some embodiments, there might be plural electrode assemblies 30.

While described above, as a particular aspect of the herein disclosed technique, it is possible to use a recitation of each item described below.
Item 1: An electricity storage device, comprising:
   a case having a liquid injection part;
   an electrode assembly accommodated in the case;
   a resin film that is arranged between the case and the electrode assembly to surround the electrode assembly; and
   an electrolytic solution accommodated in the case, wherein
   the case comprises:
      a bottom wall;
      an upper wall that is opposed to the bottom wall; and
      a first side wall that extends from a border of the bottom wall to a border of the upper wall,
   the liquid injection part is provided at a position closer to the upper wall than the bottom wall of the first side wall,
   the electrode assembly is arranged to have a bottom part being opposed to the bottom wall,
   the resin film comprises:
      a first end part that extends from one side in a predetermined direction to cover a part of the bottom part of the electrode assembly; and
      a second end part that extends along the previously determined direction from a direction opposite to the first end part and extends to cover
   a part of the bottom part of the electrode assembly, and
   a part of the second end part is stacked to overlap at the bottom wall side of the case with respect to the first end part.
Item 2: The electricity storage device recited in Item 1, wherein
   in the predetermined direction, a mean length of the first end part is longer than a mean length of the second end part.
Item 3: The electricity storage device recited in Item 1 or 2, wherein
   the second end part comprises an electrode assembly opposed part in which the second end part and the electrode assembly are opposed to each other not through the first end part, and
   a rate of an area size of the electrode assembly opposed part is equal to or more than 50% when an area size of the bottom part of the electrode assembly is treated as 100%.
Item 4: The electricity storage device recited in any one of Items 1 to 3, wherein
   a rate of an area size of a portion at which the first end part and the second end part are stacked to overlap is equal to or less than 50% when the area size of the bottom part of the electrode assembly is treated as 100%.
Item 5: The electricity storage device recited in any one of Items 1 to 4, wherein
   a mean length of the second end part is equal to or more than 70 when a thickness of the electrode assembly in the predetermined direction is treated as 100.
Item 6: The electricity storage device recited in any one of Items 1 to 5, wherein
   a mean length of the first end part is equal to or less than 50 when the thickness of the electrode assembly in the predetermined direction is treated as 100.
Item 7: The electricity storage device recited in any one of Items 1 to 6, wherein
   on a portion in which the first end part and the second end part are stacked to overlap, the first end part and the second end part are not welded.
Item 8: The electricity storage device recited in any one of Items 1 to 7, further comprising a positive electrode terminal and a negative electrode terminal, wherein
   the electrode assembly comprises a positive electrode and a negative electrode,
   the positive electrode terminal is electrically connected to the positive electrode of the electrode assembly,
   the negative electrode terminal is electrically connected to the negative electrode of the electrode assembly,
   the case further comprises a second side wall that is opposed to the first side wall,
   the positive electrode terminal is arranged on the first side wall or the second side wall, and
   the negative electrode terminal is arranged on the first side wall or on the second side wall at which the positive electrode terminal is not arranged.
Item 9: The electricity storage device recited in Item 8, wherein
   the case comprises:
      a case main body having a cylindrical shape and comprising the bottom wall and the upper wall;
      a first lid as the first side wall; and
      a second lid as the second side wall, wherein
   the case main body comprises a first opening and a second opening that is positioned at a side opposite to the first opening,
   the first lid is installed on the first opening, and
   the second lid is installed on the second opening.

What is claimed is:

1. An electricity storage device, comprising:
a case having a liquid injection part;
an electrode assembly accommodated in the case;
a resin film arranged between the case and the electrode assembly to surround the electrode assembly; and
an electrolytic solution accommodated in the case, wherein the case comprises:
a bottom wall;
an upper wall that is opposed to the bottom wall; and
a first side wall that extends from a border of the bottom wall to a border of the upper wall,
the liquid injection part is provided at a position closer to the upper wall than the bottom wall of the first side wall,
the electrode assembly is arranged to have a bottom part being opposed to the bottom wall,
the resin film comprises:
a first end part that extends from one side in a predetermined direction to cover a part of the bottom part of the electrode assembly; and
a second end part that extends along the previously determined direction from a direction opposite to the first end part and extends to cover a part of the bottom part of the electrode assembly, and
a part of the second end part is stacked to overlap at the bottom wall side of the case with respect to the first end part.

2. The electricity storage device according to claim 1, wherein
in the predetermined direction, a mean length of the first end part is longer than a mean length of the second end part.

3. The electricity storage device according to claim 1, wherein
the second end part comprises an electrode assembly opposed part in which the second end part and the electrode assembly are opposed to each other not through the first end part, and
a rate of an area size of the electrode assembly opposed part is equal to or more than 50% when an area size of the bottom part of the electrode assembly is treated as 100%.

4. The electricity storage device according to claim 1, wherein
a rate of an area size of a portion at which the first end part and the second end part are stacked to overlap is equal to or less than 50% when the area size of the bottom part of the electrode assembly is treated as 100%.

5. The electricity storage device according to claim 1, wherein
a mean length of the second end part is equal to or more than 70 when a thickness of the electrode assembly in the predetermined direction is treated as 100.

6. The electricity storage device according to claim 1, wherein
a mean length of the first end part is equal to or less than 50 when the thickness of the electrode assembly in the predetermined direction is treated as 100.

7. The electricity storage device according to claim 1, wherein
on a portion in which the first end part and the second end part are stacked to overlap, the first end part and the second end part are not welded.

8. The electricity storage device according to claim 1, further comprising a positive electrode terminal and a negative electrode terminal, wherein
the electrode assembly comprises a positive electrode and a negative electrode,
the positive electrode terminal is electrically connected to the positive electrode of the electrode assembly,
the negative electrode terminal is electrically connected to the negative electrode of the electrode assembly,
the case further comprises a second side wall that is opposed to the first side wall,
the positive electrode terminal is arranged on the first side wall or the second side wall, and
the negative electrode terminal is arranged on the first side wall or on the second side wall at which the positive electrode terminal is not arranged.

9. The electricity storage device according to claim 8, wherein
the case comprises:
a case main body having a cylindrical shape and comprising the bottom wall and the upper wall;
a first lid as the first side wall; and
a second lid as the second side wall, wherein
the case main body comprises a first opening and a second opening that is positioned at a side opposite to the first opening,
the first lid is installed on the first opening, and
the second lid is installed on the second opening.
